(19) United States
(12) Patent Application Publication
(10) Pub. No.: US 2013/0018743 A1
(43) Pub. Date: Jan. 17, 2013

(54) ORDER ACCUMULATION WEBSITE

(71) Applicants: Billson Yang, Taipei City (TW); Tony Tung-Yu Yang, Taipei City (TW)

(72) Inventors: Billson Yang, Taipei City (TW); Tony Tung-Yu Yang, Taipei City (TW)

(21) Appl. No.: 13/182,458

(22) Filed: Jul. 14, 2011

(51) Int. Cl. G06Q 30/00

(52) U.S. Cl. 705/26.2

(57) ABSTRACT

A order accumulation website includes a pre-order unit for receiving orders of a transaction from buying at least one commodity from consumers by a name or a keyword of the commodity; other consumers can also join the transaction so as to form an accumulation of orders; a commodity database recording names, prices, qualities and packaging of the commodities; a seller bidding unit receiving a price list based on the pre-ordering good provided by the consumers; the price list being called out from the database or from a seller real time to respond the orders of the transaction; the price list being provided by default sellers firstly; wherein the pre-order is provided before the provision of the price list; and the price list lists a plurality of prices for a commodity; the prices are descended with an increment of the order quantity.

### FIELD OF THE INVENTION

The present invention relates to business models, and in particular to an order accumulation for transactions of order accumulations. The commodities used in the present invention contains practical and virtual goods and services, even includes spot goods and futures.

### BACKGROUND OF THE INVENTION

Time is a very import resource and consumers needs not to take many time in buying process. However the unequal information to the buyers and sellers have harmed the consumer's right.

Generally, an e-business is provided by the seller actively and the buyers are passively to join the business. Although a buyer can determine not to buy the commodity, in fact, the right of sellers and buyers are unequal in transactions. The buyers are distributed in various areas. They can not gather together for information exchanging, but the sellers have all the information from the buyers and can understand the behaviors of the buyers so as to provide a business model beneficial to the sellers. The purchasing orders can not be accumulated so that consumers can not discuss prices with sellers.

Group purchasing has become a popular e-business model. Currently there are two ways for group purchasing. In first way, the sellers provide a price for a sale volume and the buyers are accumulated to provide an order which satisfies the price-volume relation set by the sellers. Then all the goods are sent to one address. In the second way, the website actively provides a group purchasing request with a discount for a predetermine sales volume. However it is often that this way can not provide satisfactory services to the consumers and quality for the goods is not good.

In above two ways, prices have no relation to the sales volumes. The buyers have not right to agree about the price to the sellers. The process is controlled by the sellers. Furthermore, the prior group purchasing needs a large amount of buyers, as a result, the overall service quality is deteriorated. Sometime, the consumers are confined not to share all the services. Furthermore, the goods in group purchasing are shown with packages, while the information and quality of the goods can not provide to the consumers. In the business, there is no competition to the sellers and consumers buy the goods passively. The accumulation of orders has no effect to the price and service of the goods to be bought.

The so-call order accumulation of the present invention means to gather many orders for buying some goods. The accumulations of orders occur firstly and sellers provide a price list after the occurrence of the order accumulation. In the present invention, the price list is changeable based on the order accumulation so that the buyers have the right to agree about the prices, qualities and selling ways of the goods or services to be bought in the business process. Thus, the prices are reduced with the increment of sales volume.

### SUMMARY OF THE INVENTION

The object of the present invention is to provide a website with the function of order accumulation, in that the consumers can dynamically order a commodity through a name of the commodity or a keyword to call other consumers to join the action so as to form an accumulation of the orders, this is so called order accumulation; then sellers provides a price list based on the pre-ordering commodity provided by the consumers; the price list being called out from the database or from a seller real time to respond the orders of the transaction; the price list being provided by default sellers firstly or the website manager can invite other sellers to provide other price lists for providing more selections to consumers. However, the price is descendent with the increment of order quantity.

To achieve above object, the present invention provides an order accumulation website comprising: a central server connected to at least one consumer unit through a network; the central server including a processor and a memory; the processor serving for processing related operations; and the memory serving for storing software used in the website, related operation results and related data; a pre-order unit for receiving orders of a transaction from buying at least one commodity from consumers by a name or a keyword of the commodity; other consumers can also join the transaction so as to form an accumulation of orders, this is so called order accumulation; the pre-ordering unit recording the quantity of the order accumulation; a commodity database recording names, prices, qualities and packaging of the commodities; a seller bidding unit receiving a price list based on the pre-ordering good provided by the consumers; the price list being called out from the database or from a seller real time to respond the orders of the transaction; the price list being provided by default sellers firstly; a transaction unit connected to the pre-ordering unit and the seller database for determining the deal of the transaction and proceeding related actions; wherein the pre-order is provided before the provision of the price list; and the price list lists a plurality of prices for a commodity; the prices are descended with an increment of the order quantity.

### BRIEF DESCRIPTION OF THE DRAWINGS

FIG. 1 shows the hardware structure of the present invention.

FIG. 2 shows the block diagram about the order accumulation of the present invention.

FIG. 3 is another block diagram about the order accumulation of the present invention.

FIG. 5 is a block diagram about the accounting process of the present invention.

FIG. 6 is a block diagram about the logistic mechanism of the present invention.

FIG. 7 is a block diagram of the idea transaction of the present invention.

FIG. 8 is a block diagram about the proxy mechanism of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

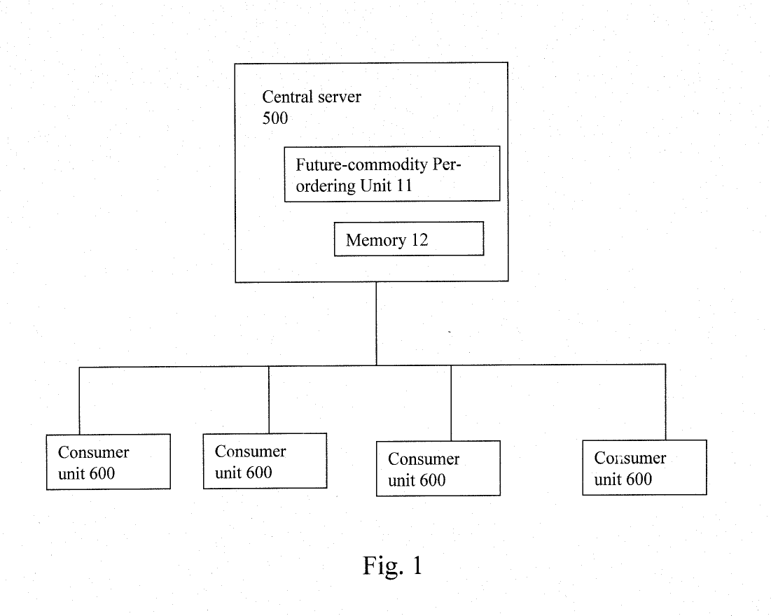

With reference to FIG. 1, the hardware structure of a central server 500 of the present invention is illustrated. The central server 500 is connected to at least one consumer unit 600 through, for example, Internet Explorer. In the present invention, all the operation software and the transaction data is stored in the central server 500. The user can make transactions in different consumer units 600. The central server 500 includes a processor 11 and a memory 12. The processor serves to process the related action of the present invention. The memory 12 serves to store the software, the operation results and related data of the present invention.

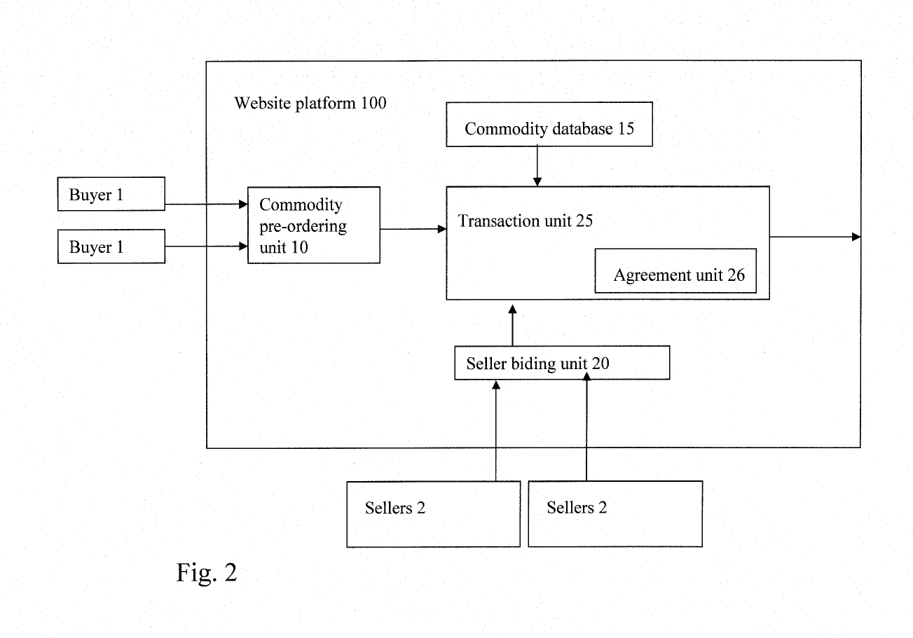

With reference to FIG. 2, the mechanism about the transactions of order accumulation of the present invention is illustrated. The detail functions of the structure will be described herein.

A commodity pre-ordering unit 10 receives at least one pre-ordering commodity from a buyer computer to buy the commodity from a pre-determined seller recorded in a seller database; and thus other buyer can join the ordering action so as to form an effect of odor accumulation. The commodity pre-ordering unit 10 will accumulate all the odors. The pre-ordering commodity may be a keyword and then the seller can provide at least one commodity related to the keyword.

In the present invention, the commodity may be a service, such as a ticket for a movie or a practical commodity, such as a shoe or a car.

A commodity database 15 records data related to all the commodities, such as names, trademarks, prices, qualities, packages, etc. of the commodities, moreover, data about the gifts, drawing lots, goods information; discounts, etc are also recorded. The commodities can be displayed automatically or passively. The automotive display serves to cause the commodities are displayed automatically on a commodity list (not shown) for being selected by buyers. The passive display causes the commodities to be displayed only if it is selected by a buyer by entering the name or related keywords of the commodity.

A seller bidding unit 20 receives a price list from a default seller for responding the pre-ordering input from the consumers. The price list is provided from the commodity database 15 or by related sellers real time. In the present invention, the seller may be one of a manufacture, an agent, a wholesaler, or a provider of an e-business.

A transaction unit 25 is connected with the commodity pre-ordering unit 10 and the seller bidding unit 20 for determining the transaction between the buyers and the sellers and performing the proceeding processes. The transaction unit 25 also records the qualities of the commodities and the satisfactions of the buyers. The comments from the buyers are published on the platform.

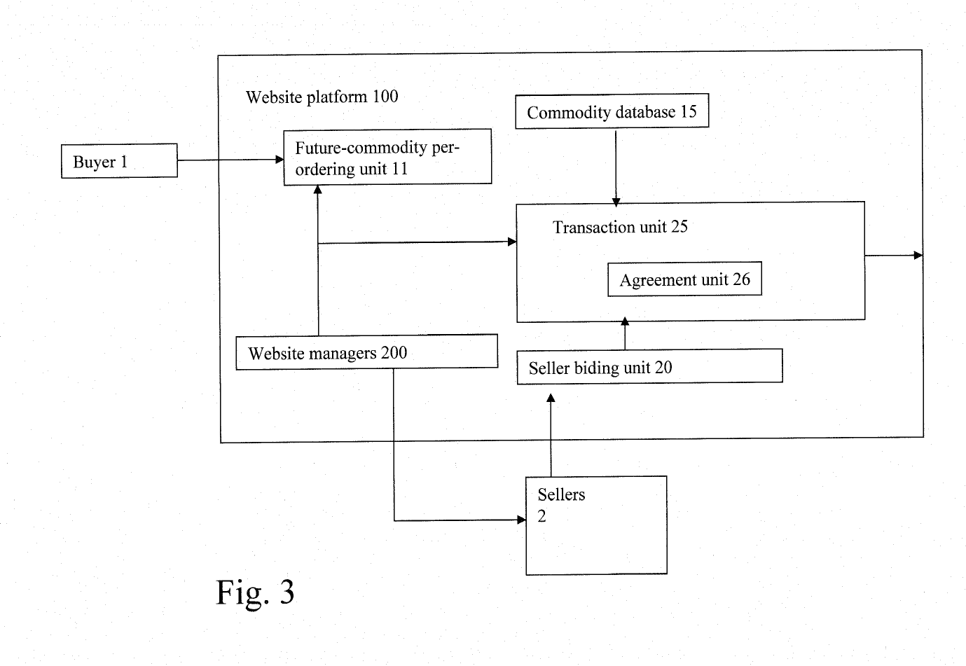

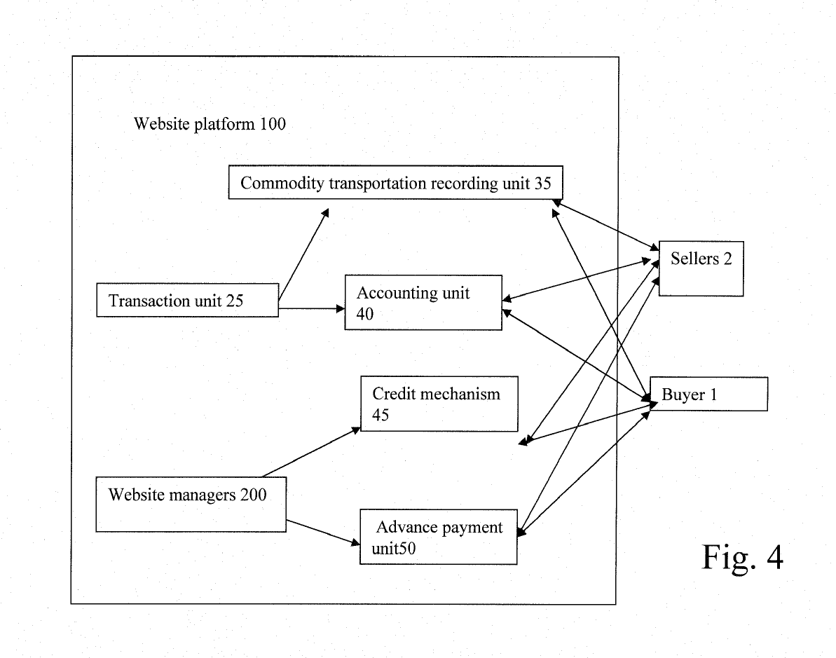

Referring to FIG. 3, it is illustrated that the present invention also includes a future-commodity per-ordering unit 11, the future-commodity may be ones of tickets for airplanes or high-valence iron, or after school lessons, etc. The future-commodity is provided by the buyers or the website managers 200. Then transaction of the future-commodity is identical to the above mentioned pre-ordering commodities as illustrated in FIG. 2.

Similarly, the future commodity may be a product which is researching now. Furthermore, the future commodity may be a real object, such as a BMW being matured in 2015, or a service commodity, such as a capital for investing in future.

With reference to FIGS. 2 and 3, the transaction unit 25 further includes an agreement unit 26. If commodity to be brought by the buyer is irreplaceable, the website manager 200 will discuss with the seller so as to have an agreement beneficial to the seller and buyers.

In the present invention, several prices for each commodity in the commodity database 15 and the seller biding unit 20 are provided based on the quantities to be bought by the buyers. The price is decreased with the increment of the quantity of the commodity to be bought. The website manager 200 can request other sellers to provide the price list about the commodity to be bought so as to compete with the original seller. Furthermore, the gifts, coupons, effective days, volumes, weights and ways for packaging are also provided if needed.

The credit mechanism of the present invention will be described herein with reference to FIG. 4.

A commodity transportation recording unit 35 serves to record the process of the transportation of the commodity. If the buyer has received the commodity, then the quality and the quantity are transferred to the platform by using a button for assuring the transaction being completed.

An accounting unit 40 serves to receive the payment from the buyers and the messages about the completeness of the transaction from the commodity transportation recording unit 35, then informing the platform to pay the fee to the seller 2.

A credit mechanism 45 provides a predetermined quota of purchase power to the buyer 1 and a predetermined amount of circulating funds to the sellers. The purchase power and the circulating fund are suitable to be used in intra-network and extra-network which are determined by the website manager 200.

An advance payment unit 50 receives the advance payment from the buyers and pays the invoices of the buyers and sellers. These operations are both used in intra-network and extra-network transactions. However the order accumulation of the present invention will reduce the prices of the commodities.

However this service simplifies the payment of the buyer 1, and the sellers 2 can retain supplies of the materials used.

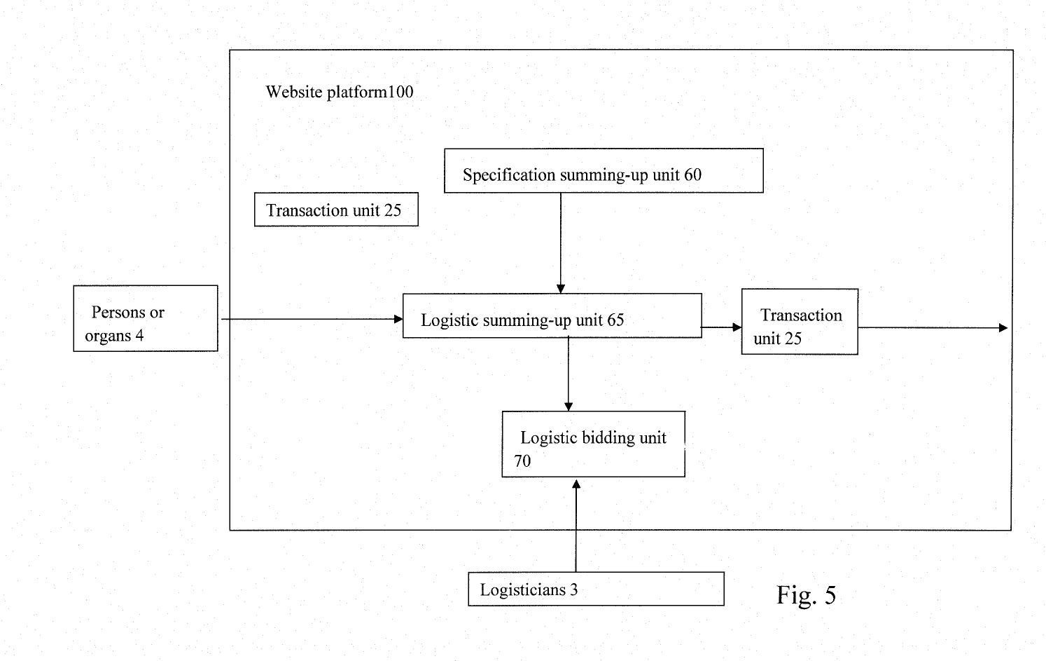

The logistic mechanism of the present invention will be described herein with reference to FIG. 5.

A specification summing-up unit 60 serves to sum up all the specifications of the commodities from the seller 2, the specification mainly includes sizes, volumes, quantities and weights and packaging of the commodity database 15.

A logistic summing-up unit 65 serves to receive the input data from the persons or organs 4 needing the logistic service.

A logistic bidding unit 70 provides services to the logisticians 3 to bid the logistic services registered to the specification summing-up unit 60 or the logistic summing-up unit 65

This function is especially useful to the logistic services for importation.

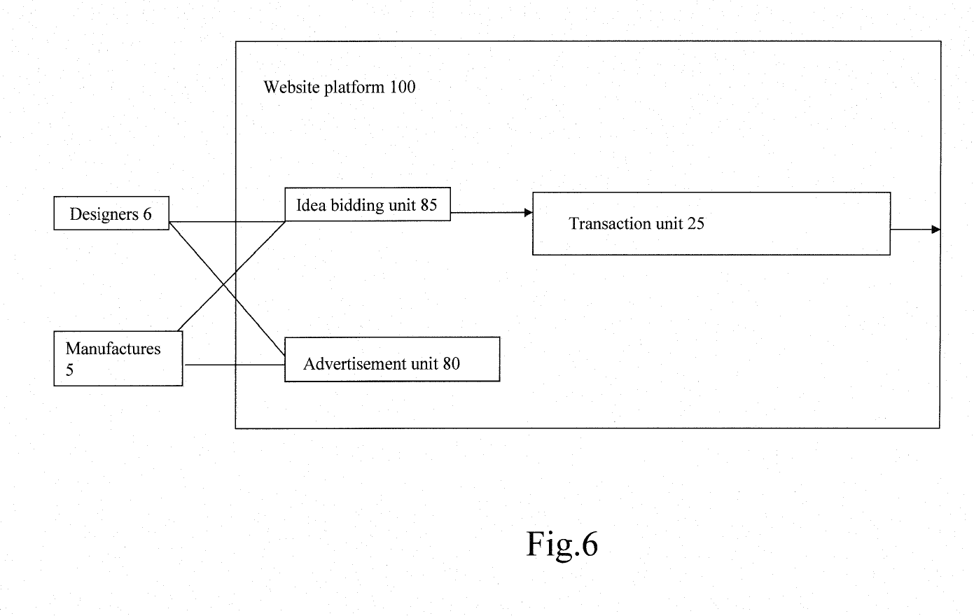

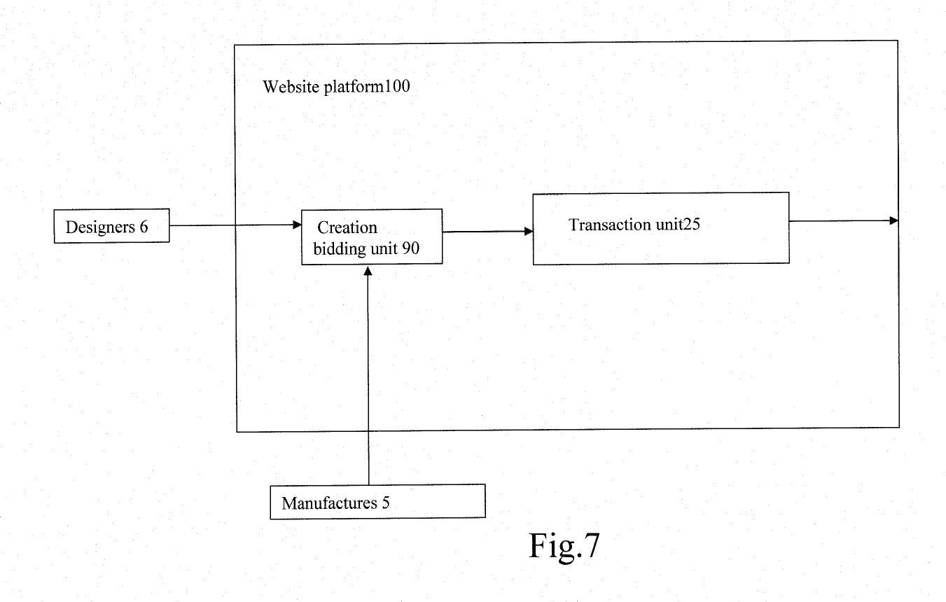

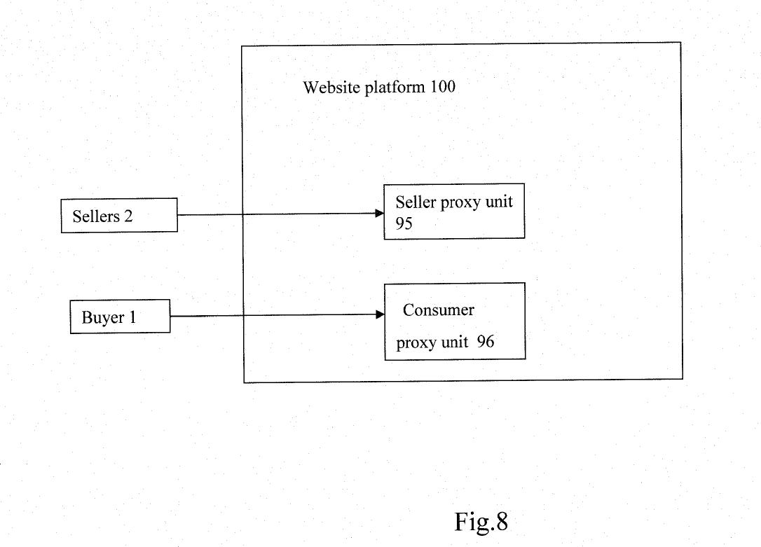

In the following, the creation and idea summing up mechanism of the present invention is described with reference to FIGS. 6 and 7.

An advertisement unit 80 provides services to the manufactures 5 so that the designers can bid the design rights of advertisement. Furthermore, the manufactures can decide the playing of the advertisement by keywords, or clicking numbers or by sales volume.

An idea bidding unit 85 provides to the manufactures so that they can provide ideas; and the designers 6 can bid the rights for realizing the ideas.

A creation bidding unit 90 provides the service to the designers 6 so that the designers 6 can disclose their creations to the creation bidding unit 90, while manufactures can bid the right for selling or making the creations.

In the following, the agent mechanism of the present invention will be described herein with reference to FIG. 7.

A seller proxy unit 95 serves to act for the sellers with set prices and conditions. Thus the sellers only engage to the works of manufacturing; and the sell of the commodities is transferred to the website side so that the website manager can sell and accumulate orders of the commodities.

A consumer proxy unit 96 receives inputs from the consumer about prices and conditions of commodities and then the website manager acts for the consumers for buying the commodities so as to form the order accumulation effect by the process of the present invention.

The above two units 95, 96 are suitable for C2C, B2C and B2B, for sellers and consumers and for both practical goods and services. The retails, wholesales, and international trades are all suitable to be performed in these two units and are suitable for all commodities.

The difference between the order accumulation of the present invention and the prior group purchase will be described herebelow.

The price and quantity relation of a commodity in the conventional group purchasing are determined by the sellers. However in the order accumulation of the present invention, the buyers accumulate the orders and the sellers bid the right for providing the commodity. In the process, the prices are changeable based on the sales volume. The process of the present invention is reversed to that of prior group purchasing. Because there are many bidding sellers, the buyers have more selection ways.

Besides, in the prior art, the seller predetermines the selling condition and then the buyer are gathered for buying the commodity. To retain the profit of the e-business website, the commodities are high profited ones. However conventional group purchasing is suitable for various commodities. Once the orders of the buyers are accumulated, the seller can determine the prices of different levels based on the sales volume in the process of the order accumulation.

Furthermore, the prior group purchasing is performed at times, not a regular selling behavior. It is often a selling behavior for advertisement. However in the website of the present invention, the order accumulation is a regular business model with a very wide coverage. The buyer orders are accumulated to change the price which is reduced with the order quantity. The sales volume is lager, and thus the overall cost in the business process is greatly reduced.

The orders are accumulated so that the original retail sale will become a business of wholesale, even the sales volume will enlarge to the volume of exportation. Thus, the website of the present invention is equally as a business center for accumulating orders and all the agents and sellers must take attention to the provision of prices so that the consumer right can be promoted. Moreover, sellers all over the world can join the bidding process and the buyers can select many different price lists from different sellers. Therefore, retailers and wholesalers provide their service based on this model.

Furthermore, in current group purchasing, almost only one price is provided the price has no relation to the sales volume. In the present invention, the price levels must be provided and the sellers can enter into the bidding process randomly so that the consumer right is enlarged extremely.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims

What is claimed is:

1. An order accumulation website comprising:
a central server connected to at least one consumer unit through a network; the central server including a processor and a memory; the processor serving for processing related operations; and the memory serving for storing software used in the website, related operation results and related data;
a pre-order unit for receiving orders of a transaction from buying at least one commodity from consumers by a name or a keyword of the commodity; other consumers can also join the transaction so as to form an accumulation of orders, this is so called order accumulation; the pre-ordering unit recording the quantity of the order accumulation;
a commodity database recording names, prices, qualities and packaging of the commodities;
a seller bidding unit receiving a price list based on the pre-ordering good provided by the consumers; the price list being called out from the database or from a seller real time to respond the orders of the transaction; the price list being provided by default sellers firstly;
a transaction unit connected to the pre-ordering unit and the seller database for determining the deal of the transaction and proceeding related actions;
wherein the pre-order is provided before the provision of the price list; and the price list lists a plurality of prices for a commodity; the prices are descended with an increment of the order quantity.

2. The order accumulation website as claimed in claim 1, wherein under the grant of a website manager, other non-default seller can join to the action of providing the price list.

3. The order accumulation website as claimed in claimed 1, further comprising a future commodity pre-order unit for pre-ordering a commodity in future.

4. The order accumulation website as claimed in claimed 1, wherein commodity in the seller database is displayed without an ordering action from the consumers.

5. The order accumulation website as claimed in claimed 1, further comprising a negotiation unit for making negotiating between the consumers and the sellers.

6. The order accumulation website as claimed in claimed 1, further comprising a credit mechanism which provides a predetermined quota of purchase power to the consumer and a predetermined amount of circulating fund to the sellers; the purchase power and the circulating fund are suitable to be used in intra-network and in extra-network which are determined by the website manager.

7. The order accumulation website as claimed in claimed 1, further comprising an advance payment unit which receives the advance payment from and pay the invoices of the buyers and sellers; these operations are both used in intra-network and extra-network transactions; and the order accumulation will reduce the prices of the commodities.

8. The order accumulation website as claimed in claimed 1, further comprising
a specification summing-up unit for summing up all specifications of the commodities from the seller, the specification includes sizes, volumes, quantities and weights and packaging of the commodity database;
a logistic summing-up unit for receiving the input data from the persons or organs needing the logistic service; and
a logistic bidding unit providing services to the logisticians to bid the logistic services registered to the specification summing-up unit or the logistic summing-up unit.

9. The order accumulation website as claimed in claimed 1, further comprising:
an advertisement unit providing services to manufactures so that designers can bid design rights of advertisement; furthermore, the manufactures can decide the playing of the advertises by keywords, or clicking numbers or by sales volume.

10. The order accumulation website as claimed in claimed 1, further comprising:
an idea bidding unit providing to manufactures so that they can provide ideas and designers can bid the rights for realizing the ideas through the creation requesting unit.

11. The order accumulation website as claimed in claimed 1, further comprising:
a creation bidding unit providing to designers so that the designers can disclose their creations to the unit, while manufactures can bid the right for selling or making the creations.

12. The order accumulation website as claimed in claimed 1, further comprising:
a seller proxy unit for receiving set prices and conditions for goods from sellers; so that the website manager can sell and accumulate orders of the commodities.

13. The order accumulation website as claimed in claimed 1, further comprising:
a consumer proxy unit receiving inputs from the consumer about prices and condition of a commodity and then the website manager acts for the consumers for buying the commodities.

14. The order accumulation website as claimed in claimed 1, the commodities are ones of practical goods, virtual goods, or services.

15. The order accumulation website as claimed in claimed 1, wherein the commodities are one of spot goods and futures.
